(19) United States
(12) Patent Application Publication
(10) Pub. No.: US 2016/0196704 A1
(43) Pub. Date: Jul. 7, 2016

(54) SYSTEM FOR VITUALIZING AND CENTRALIZING THE SECURITY GUARD FUNCTIONS OF AUTHORIZATION AND AUTHENTICATION OF ENTRANTS AT UNMANNED SITES

(71) Applicant: EdgeConneX, Inc., Herndon, VA (US)

(72) Inventors: Lance Devin, Vienna, VA (US); Max Stayner, Chagrin Falls, OH (US)

(73) Assignee: EdgeConneX, Inc., Herndon, VA (US)

(21) Appl. No.: 15/016,573

(22) Filed: Feb. 5, 2016

Related U.S. Application Data
(60) Provisional application No. 62/176,181, filed on Feb. 12, 2015.

(51) Int. Cl. G07C 9/00

(52) U.S. Cl. CPC G07C 9/00158; G07C 9/00166

(57) ABSTRACT

A system for vitualizing and centralizing the security guard functions of authorization and authentication of entrants at unmanned sites

This application is based on provisional application Ser. No. 62/176,181 filed Feb. 12, 2015

### FEDERALLY SPONSORED RESEARCH STATEMENT

Not Applicable

### REFERENCE TO SEQUENCE LISTING, A TABLE OR A COMPUTER PROGRAM LISTING

Not applicable

### BACKGROUND OF THE INVENTION

### Field of the Invention

Physical security of premises such as data centers, power plants, government facilities and the like is an important consideration in the operation of businesses housed in those premises. In the example of a data center operator who is responsible for the operation of multiple data centers in different locations with each data center having one or more customers, operators and vendors, insuring that only appropriate people enter the premises is a major responsibility and is typically handled using on-site personnel. The inefficiency and cost for such service in terms of labor and dedicated security equipment at each location can become prohibitive and have a negative effect on the efficiency and profitability of the data center operation company.

### BRIEF SUMMARY OF THE INVENTION

It is the objective of the inventive security system to provide appropriate protection to a plurality of unmanned locations at reduced labor costs via a simplified process from a remote location (s). More specifically, the subject security system accomplishes all of the objectives without the use of on-site personnel. In order to accomplish these objectives the protective system features the use of multi-dimensional criteria to assign individualized access across the multiple locations, each location having multi-zoned areas. Further, the subject security system utilizes automated messaging to provide secured access to an entrant through a specific door of an unmanned data center that has not been heretofore defined as the entrant's pre-approved access level. Still further, the inventive process has the capability of using existing IP cameras located in view of doorways in the data center to provide an instant image of an entrant for security purposes without the need for dedicated hardware, personnel, or extensive manual processes. In the event there are multiple requests for entry into unmanned facilities at different locations during the same time period a significant feature of the invention is directed to a queuing control to enable security operation housed at one or more remote locations to respond to a plurality of separate entry requests simultaneously.

In order to accomplish the objectives of the invention there must be the capability of insuring that entrants into any of the secured unmanned data centers are allowed entry for legitimate reasons and have access to their specific areas of interest in that data center. To that end entrants are provided access to a location based on defined access levels. As is explained in the detailed explanation of the invention below the access levels are pre-defined and has the capability of allowing individual access to pre-determined areas in any of a several locations.

It is to be noted that the inventive system is a bespoke application providing the aforementioned functionality in addition to that of any commercially available security system that provides an adequate application programming interface (API).

### DESCRIPTION OF FIGURES

FIG. 1 is a comprehensive schematic of the Virtual Guard System

FIG. 2 is a schematic showing the information flow for the pre-registration mode of the inventive system.

FIG. 3 is a schematic showing the information flow for the pre-registered entry mode of the inventive system.

FIG. 4 is a schematic showing the information flow of the in situ registration and entry mode of the inventive system,

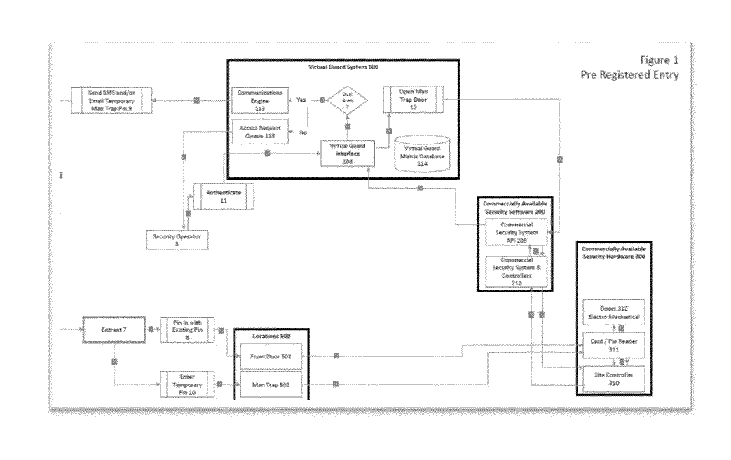

### DETAILED EXPLANATION OF INVENTION DEFINITIONS AND EXPLANATION OF TERMS SPECIFIC TO THE DISCLOSURE

Communications Engine 113: A bespoke application module that uses standards-based communications protocols to communicate from the virtual guard system 100 to entrant 5, entrant 7-1, and entrant 7-2, in the form of email or Short Message Service (SMS).

Access Request Queue 118: A bespoke application module that receives requests from entrants at all sites and puts them in the order of first request received is the first request to be processed (“First in/First Out” queuing). This list is acted upon by security operators 3 for performing the functions of the virtual security guard. Access request queue 118 knows about an entry because entrant 7-1 enters a PIN into card/pin reader 311 which then communicates that PIN through site controller 310, which passes that information to commercially available security software 200, which in turn programmatically communicates the entrant 7-1 identity and location to virtual guard interface 108 and subsequently to access request queue 118.

Virtual Guard Interface 108: A bespoke application interface, programmed in commercially available programming language. It provides the user experience for the whole virtual guard system to the security operator. A separate instance of the interface is presented to each individual security operator 3. More than one security operator 3 can use the virtual guard system 100 at any given time.

Virtual Guard Matrix Database 114: A commercially available relational database is used to define a bespoke set of tables and relational database structures that represent the access levels that need to be applied to an entrant representing any given company, at a site, and with a role. This is explained in detail below.

Commercial Security System API 209: A module often provided by the commercial security system 200 software that allows you to programmatically control and pass information between a bespoke application and the commercial system.

Commercial Security System & Controllers 210: Commercially available security software residing in one centralized location communicates to commercially purchased physical site controller 310 that exist at many sites. Physical site controller 310 stores entrant access levels and determines if a PIN entered by entrant is valid for an entryway. If valid, the controller sends an electro-mechanical pulse to doors 312 to unlock. There may be one or more physical site controllers 310 at a site as each controller has a limit to the number of doors that it can control.

Electro-Mechanical Doors 312: A commercially available physical door. Each site has entry ways that may or may not have a door. An electro-mechanical door 312 can be locked or unlocked by site controller 310. There may be one or more doors at any site, and in this document is used to represent any given door for the purposes of description.

Card/PIN reader 311: A commercially available physical device used to read badges or collect pins from entrants. An electro-mechanical door 312 may have zero to two card/PIN readers as defined by the use case of the door. In this document, a card/PIN reader is used to represent any given card/PIN reader for the purposes of description. There are card/PIN readers 311 on the front door 501 for entry, two on barrier door 502 for entry and exit.

Site Controller 310: A commercially available physical device installed at a site. For the purposes of this document, there may be one or more site controllers at any given site, controlling one or many electro-mechanical doors 312 at a site. A site controller has two-way communication between Card/PIN reader 311 as well as commercially available security software 200, and by doing so ultimately gives control of doors and access control to virtual guard system 100.

Security Operator 3: Defines a role of any person whose responsibility is to administer access to data centers for desired entrants. The security operator does not need a physical presence at a site, as long as they have access to Virtual Guard System 100. The Security Operator 3 may represent one person, or many persons, in one or many locations.

Credentials 4: Is a set of data collected about an entrant that uniquely identifies that entrant. Credentials may be defined for any given circumstance related to security, however in the preferred embodiment comprises: First Name, Last Name, Government ID Type, Government ID number, mobile phone number, email, photo, and company.

One-step Direct to Credential Process: In the process of collecting credentials from entrant 6 in the In Situ Registration and Entry process, a photo credential must be taken. Using standard purposeful surveillance cameras, the invention takes a snapshot from the IP Camera 317 using network video recorder 416 software, maintains that image in memory, and communicates the image to virtual guard interface 108 via the NVR API (Application Programming Interface). The picture is immediately stored as the photo credential 4 of entrant 6 in the commercial security system & controllers 210 via the commercial security system API 209. From security operator 3's perspective, this sequence of events is merely a push of a button in virtual guard interface 108 called “Take Picture”.

In a preferred embodiment each of the multiple locations or sites are data centers with each center having commonly and uniformly defined areas or zones with different functional purposes such as common areas, data center space, loading, electrical and customer equipment. The common areas include lobbies, bathrooms, corridors and the like. Data center space includes rooms housing computer equipment. Storage areas are those in which equipment is stored. Loading is done at the loading dock and is the area through which various items and equipment are delivered into the site. The electrical room is a common area housing all power plant equipment. The customer equipment is housed in areas called cages. Each of several customers may have one or more cages depending on the amount of equipment needed.

Entrants to the data center are classified as to the reason each has to enter the site. For example, electricians should be allowed access to the common areas and electrical rooms; customers should have access to the common areas, data center space and its designated cages; persons delivering items should have access to the loading dock etc.

In the case of a data center operator that manages multiple unmanned sites from a remote location the assignment of access levels to a growing list of entrants becomes a complicated task. In prior art systems a security guard assigned to a specific site must insure the identity and purpose of an entrant that has not been pre-approved, authenticate an entrant who has been pre-approved, assign access levels to the entrant, authorize the defined access level for the entrant, and issue a physical badge, card or PIN (Personal Identification Number) to the entrant to be used to access the particular areas of the data center to which the entrant is authorized.

In the inventive system the access level control takes into consideration all of the various areas of a specific site in which controls are necessary. Access levels are assigned to entrants either on a pre-registration basis or on an ad-hoc basis. The pre-registration is sometimes referred to as the A Priori Access Request in the preferred embodiment of the invention. Access levels issued on an ad-hoc basis is sometimes referred to as an In Situ Request in the preferred embodiment.

After a person who has applied for pre-registration has been authorized, a specific access level is assigned. Each assigned access level determines the entry ways in each particular site that will allow entry by that entrant with an associated PIN. To appreciate this feature of the invention it is to be realized that there are many possibilities of levels for access. An entrant's assigned access level is determined by applying pre-determined classifications relevant to that entrant. Classifications are important or there would be a metaphorically infinite number of possible access levels for each individual entrant (number of doors raised to the power of 2—options) and impractical to administrate. In the preferred embodiment of the invention the pre-determined classifications are the entrant type, the badge type and site location. A classification can be a refinement of an existing classification or an entirely new type of classification (orthogonal in nature). The entrant type is defined by the company or companies the entrant represents and by extension the function they perform in the facility. In the preferred embodiment, there are entrant types such as “Customer”, “Maintenance”, “IT”, “Janitorial”, etc. More than one company can be categorized as “Maintenance” with each employee of that company being assigned the “Maintenance” access level. The badge type is a further refinement of the functional responsibilities of the entrant for that specific entrant type. For example, an entrant that is responsible for maintenance has pre-determined access to those rooms in the buildings in which maintenance must be performed. An example of the refinement could be entrant type equals maintenance, badge type equals electrical or mechanical. The electrical maintenance person can go into the electrical rooms whereby the maintenance mechanicals badge type would not, and vice versa. The site location refers to the geographical location of the particular site defined by its address.

If we were to take the example further through each of the dimensions, the result would be entrant type equal to “Maintenance”, badge type equal to “electrical”, and work can be performed at site 1 and site 2 but not site 3. In so doing, we quickly and easily can assign the minimum number of entry ways in all the facilities that any entrant can have access to and by doing so maintain the integrity of site security.

In the preferred embodiment, in order to automatically control access to each site, a three-dimensional matrix has been designed that designates the entrant type, badge type and site location of each pre-approved entrant so that upon that entrant being authorized his/her access level is automatically and dynamically programmed to allow access to all of the entry ways designated to that assigned access level.

It is possible for an entrant to be assigned two sets of access levels based on for whom the work is to be performed, which is defined in this application as the “On-Behalf-Of” company. In that case, a different unique PIN will be assigned to each set of access levels. In the preferred embodiment an example is a service vendor on behalf of a customer 1 and who is also on behalf of a different customer 2. Customer 1 access levels include access to customer 1's equipment located in their own caged areas and customer 2 access levels include access to customer 2's equipment located in their caged areas.

Furthermore, the preferred embodiment of the inventive system has an established relationship between the Company and the On-Behalf-Of Company such that the virtual guard Interface 108 (shown in the figures) can be simplified for security operator 3. While there can be many vendor companies across multiple sites, for example, there are substantially less “On-behalf-of” companies, thus simplifying the task of assigning an access level. One of the dimensions in the matrix database 114 is the assignment of the entrant type. This is determined by the On-Behalf Of credential. The virtual guard interface 108 is automatically simplified when the Company credential, as indicated by the entrant 5, is associated to the On-behalf-of company credential. Each “On-behalf-of” company has a limited number of possible entrant types (customer or maintenance or janitorial), and further reductions in Badge Types (electrical, mechanical, customer, etc.).

In practice of the preferred embodiment of the invention the number of doors raised to the power of 2 total access level options in a commercial security system is reduced to three simple questions: “Who are you On-behalf-of (entrant type)”, “what specialty do you represent (badge Type)”, and what sites do you need entry to (sites).” The answers to which enables the system to dynamically set the access level of the entrant.

Pre-Registration Process

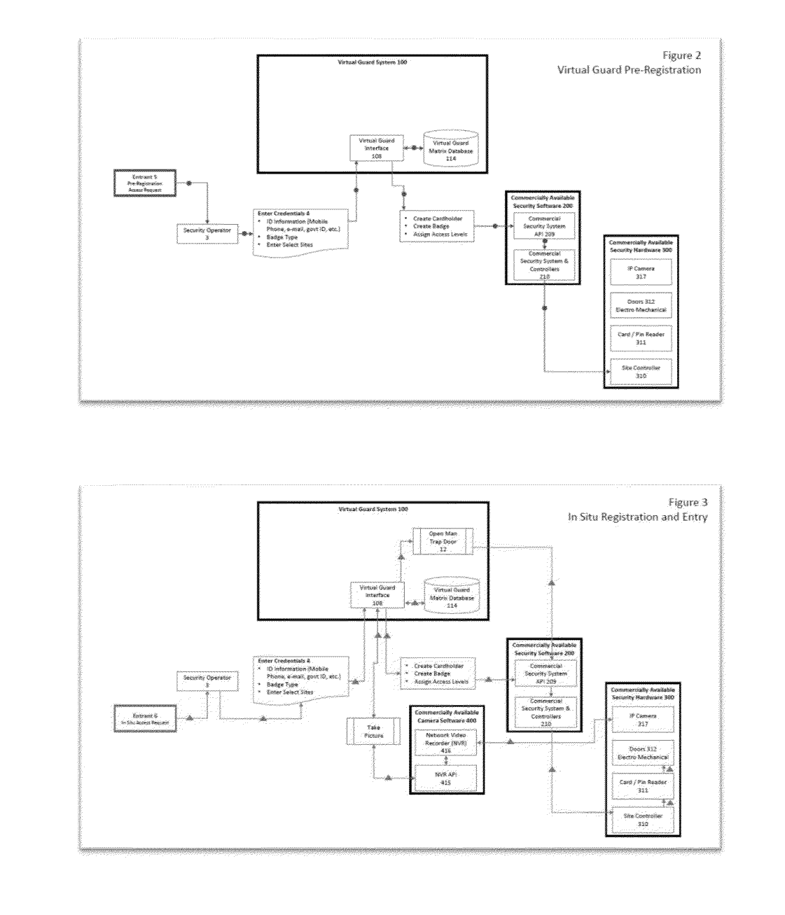

FIG. 2 shows the information flow that is employed to pre-register a candidate who desires to be approved for access to one or more sites at a later time (“Pre-registration and/or A Priori Request”). Entrant 5 completes a pre-determined credentials form and submits the form via the internet or email to security operator 3. Security operator 3 may be located at a centralized location or in different geographical areas and can be part of the network operations center (NOC) for the entire network of data centers. It is to be understood that the data centers under control of security operator 3 are located in various locations throughout the world. The minimally required information in the request for pre-approval includes the future entrant 5's: picture, copy of his/hers government ID type, associated ID number, mobile telephone number, email address, other identifying information, the sites they have reason to access, the company being represented, and the company for which work will be performed (“On-Behalf-Of Company”). There are various companies that have employees or contractors needing access to the data center including service venders, customers and operator personnel. All of the information given by the candidate is entered into guard interface 108 and analyzed visa vie the matrix database 114. Entrant 5 is then assigned appropriate access levels as defined by the matrix database 114 and virtual guard system 100. Entrant 5's information and access levels are directed into commercially available security application programming interface API 209 and controller 210 and security hardware 300 consisting of electro mechanical doors 312, PIN readers 311 and site controller 310. Eventually entrant 5 will enter a site as entrant 7 in FIG. 3 further described below.

Upon approval of the pre-registration application (“Authorization”) the applicant is given a PIN to be used for access into and throughout a site or set of sites, with the exception of the barrier door 502 in FIG. 3. Barrier door 502 is an entry way that is never assigned in the access control to any entrant and therefore does not allow that entrant to go through it without a second level of authentication beyond the PIN. In the preferred embodiment, a second level of authentication will be performed either by security operator 3 or through an SMS message sent to a mobile phone that is associated to entrant 7-2.

FIG. 3 is a diagram of information flow once a pre-approved entrant 7-1 arrives at a site and seeks access thereto. Typically, the main access to a data center is through front door 501 that leads into room commonly referred to as a mantrap. Mantrap 500 is a small area having front door 501 on one wall and barrier door 502 on the opposite wall that leads into the interior of the data center building. The pre-approved entrant 7-1 enters his/hers unique PIN previously issued by security operator 3 during the pre-registration process, into front door 501's PIN reader 311. The entrant 7-1, now in man trap 500, cannot access the locked barrier door 502 to enter the interior of the center using their unique PIN. Virtual guard system 100 determines, based on the entrant 7-1 identity automatically retrieved from the commercially available security software 200 via the commercially available security hardware 300, whether dual authentication will be performed by security operator 3 or an SMS authentication mechanism. Dual authentication is the term used for using two distinct forms of identity unique to an entrant to ensure that an entrant is the person they say they are. The preferred criteria to perform the SMS authentication mechanism is a valid mobile phone number entered during the pre-registration process, and whether the entrant 7-1 has only one set of access levels assigned. If both criteria are true, we refer to them in FIG. 3 as entrant 7-2.

If either criteria is not met, security operator 3 takes the entrance request from an access request queue 118 to be described below, to then perform the second authentication. In order to gain access out of the man trap the identity of the entrant 7-1 must be confirmed by the interaction between security operator 3 through virtual guard interface 108 retrieving data from commercially available security software 200. Security operator 3 checks the ID type and ID number as well as the photo in comparison to view of the entrant 7-1 made available by IP Camera 317 to ensure that the person is who they say they are. If a positive identification is made (second authentication), Security operator 3 uses virtual guard interface 108 to initiate an open door event sent through commercial security system 200 through to the commercially available security hardware 300.

A feature of the inventive system is the ability to provide automatic dual authentication or double confirmation using SMS. If the virtual guard system 100 determines that an SMS authentication can be performed, then a standards-based short message service (SMS) communication is sent to the entrant 7-2's mobile telephone. Entrant 7-2 enters the one-time, temporary PIN 10 issued by communications engine 113 for use to unlock the man trap barrier door 502. It is to be understood that the entrant's mobile telephone number is stored in the data base 114 and is delivered via interface 108 to communications engine 113.

If permission is not granted or the entrant 7-1 does not have his/her mobile telephone available dual authentication is not possible. In that event the request for entry by the entrant is communicated to access request queue 118 and that request is retrieved by security operator 3 from request queue 118. The purpose of the access request queue 118 is to ensure an efficient processing of entrants on a first in, first out queue of entrants. The unique aspect related to access request queue 118 is that when having to respond to multiple requests for entry at multiple locations the queue is a virtual one as if the entrants were in line at a single location. In accordance with the invention when there is more than one request for entry to a site and or different there is made available as many security operators 3 that is needed to handles the requests in the order resulting in an efficient processing of entry requests.

Ad Hoc/In Situ Entry

When entrant 6, who is physically at the site but has not been pre-approved, seeks to enter an unmanned site protected by the inventive system, he/she uses an intercom located outside the front door 501 that communicates with security operator 3. Upon approval, security operator 3 unlocks front door 501 and entrant 6 is able to gain access to the man trap. Once in the man trap entrant 6 uses the intercom at barrier door 502 to call security operator 3 for the start of credential collection, authorization and the authentication process. At that time the entrant's credentials (identical to the information required for pre-approval) are obtained by security operator 3. All obtained credentials are inputed into guard interface 108. Security operator 3 instructs entrant 6 to face the IP camera 317 in man trap 500 and uses an innovative one-step, direct-to-credential storage process. Virtual guard interface 108 uses NVR API 415 to take the picture, stores that picture in computer memory and associates that picture with credentials as well as access levels defined by virtual guard matrix database 114, then stores all that information in commercially available security software 200 using the commercial security system API 209. It is to be understood that this system, can be operated remotely, does not require any dedicated hardware associated with the operation of the camera, nor does it require specialized commercially available security software.

Next, Virtual guard interface 108, using matrix database 114, automatically prompts security operator 3 with the On-Behalf-Of Company's dedicated authorizer's phone number. If properly authorized by the On-Behalf-Of company, security operator 3 sends authorization to commercial security system API 209 for database storage in commercially available security software 200 and the localized storage in Site Controller 310. Upon confirmation of the authorization of entrant 6, a PIN is given to entrant 6 which associates with the assigned access levels. Security operator 3 then uses virtual guard interface 8 to unlock barrier door 502 for entrance into the interior data center. Entrant 6 can then use the given PIN to enter the assigned areas in the site and access the appropriate entry ways. At this point in time, entrant 6 is now considered pre-registered and would use process flows defined in FIG. 3 as entrant 5.

There has been provided herein an approach to provide a security system that controls the access to unmanned sites. The protective system features the use of multi-dimensional criteria to assign individualized access across the multiple locations, each location having multi-zoned areas. Further, the subject security system utilizes automated messaging to provide secured dual authentication access to an entrant through a specific barrier door of an unmanned data center that has not been heretofore defined as the entrant's pre-approved access level. Still further, the inventive process has the capability of using existing IP cameras located in view of doorways in the data center to provide an instant image of an entrant for security purposes without the need for dedicated hardware. In the event there are multiple requests for entry into unmanned facilities at different locations during the same time period a significant feature of the invention is directed to a queuing control to enable security operation housed at a remote centralized location to respond to a plurality of separate entry requests simultaneously.

While the invention has been particularly shown and described in conjunction with a preferred embodiment thereof, it will be appreciated that variations and modifications will occur to those skilled in the art. Therefore, it is to be understood that the claims are intended to cover all such modifications and changes as fall within the true spirit of the invention.

1. A method of registration into a security system, of a candidate-for-entry into an unmanned secured facility that systematically verifies a uniqueness check of the credentials of said candidate-for-entry against existing credentials in said security system including the steps of:
collecting credential information from said candidate,
determining that said credential of said candidate-for-entry, is unique to said security system, and
registering said candidate upon said determination of uniqueness.

2. The method of claim 1, wherein the determination of a unique credential is accomplished by comparing collected credential information to a database of existing credential information in said security system.

3. A method of assigning to a candidate-for-entry a set of access levels to one or more multi-zoned, unmanned facilities including the steps of:
determining classifications relevant to said candidate-for-entry
authorizing said candidate-for-entry,
comparing said classifications to a three dimensional matrix which provides the access levels required by said candidate-for-entry,
creating the resulting access levels for said candidate-for-entry into said security system,
assigning said access levels to said candidate for entry.

4. The method of claim 3 wherein authorizing said candidate-for-entry includes prompting a security operator with a specific process based on said candidate-for-entry's classifications

5. A method of authorizing a representative of a business entity as a candidate-for-entry into an unmanned, multi-zoned secure facility under control of a security operator located in a remote location from said facility, including the steps of;
allowing said candidate-for-entry to enter into a confined area in said secured facility that has access to the interior of said secured facility,
providing a communication link between said candidate-for-entry and said security operator,
providing the credentials including the contact information of said business entity to said security operator,
having said security operator communicate with said business entity to confirm the identity of said candidate-for-entry and whether said candidate-for-entry should be allowed access, and
upon confirmation of the identity of said candidate-for-entry authorizing access to said candidate-for-entry to predetermined zones in said secured facility.

6. A method of claim 1 wherein collecting credential information from said candidate includes a picture retrieved from any security camera and in one-step applies said picture to the credential of said candidate-for-entry.

7. A method of adding a picture taken from a non-specific camera located in an unmanned, multi-zone facility in a one-step method, to a credential of a candidate-for-entry to said unmanned, multi-zoned facility wherein said picture is made part of a dual authentication process including the steps of:
allowing said candidate-for-entry into a space having a camera,
instructing said candidate-for-entry to position themselves in front of said camera,
having a remote security operator activate said camera to take said picture of said candidate-for-entry, transmit said picture to said security system, and saving said picture in the credential of said candidate-for-entry.

8. A method of allowing pre-approved candidates-for-entry each having a unique PIN into an unmanned multi-zoned facility including the steps of:
having said candidate-for-entry enter said unique PIN into the front door PIN reader of said facility,
allowing said candidate-for-entry access into a mantrap,
determining the identity of said candidate-for-entry using multiple forms of authentication, and
upon the determination of said identity, opening a barrier door to allow said candidate-for-entry to leave said mantrap and enter into the interior of said facility.

9. A method of claim 8 wherein determining the identity of said candidate-for-entry using multiple forms of authentication, includes SMS as a means of authentication.

10. A method of claim 8 wherein opening said barrier door is performed by said candidate-for-entry receiving an SMS with a single use, time expiring PIN.

11. A method of allowing pre-approved candidates-for-entry each having a unique PIN into an unmanned multi-zoned facility having a barrier door including the steps of:
having said candidate-for-entry enter said unique PIN into the PIN reader on said barrier door of said facility,
determining the identity of said candidate-for-entry using multiple forms of authentication, and
upon the determination of said identity, opening said barrier door to allow said candidate-for-entry to I enter into the interior of said facility.

12. A method of claim 11 wherein determining the identity of said candidate-for-entry using multiple forms of authentication, includes SMS as a means of authentication.

13. A method of claim 11 wherein opening said barrier door is performed by said candidate-for-entry receiving an SMS with a single use, time expiring PIN.
